(19) United States
(12) Patent Application Publication
(10) Pub. No.: US 2025/0037214 A1
(43) Pub. Date: Jan. 30, 2025

(54) SYSTEMS AND METHODS FOR STOCHASTIC MODELING FOR DRILLING FORECASTS

(71) Applicant: Saudi Arabian Oil Company, Dhahran (SA)

(72) Inventors: Hasan A. Nooruddin, Dhahran (SA); Mohammed A. Shahri, Dhahran (SA); Aidah G. Zahrani, Dammam (SA)

(73) Assignee: Saudi Arabian Oil Company, Dhahran (SA)

(21) Appl. No.: 18/358,649

(22) Filed: Jul. 25, 2023

(51) Int. Cl. G06Q 50/02; E21B 41/00; G06F 17/18

(52) U.S. Cl. CPC G06Q 50/02; E21B 41/00; G06F 17/18; E21B 2200/20

(57) ABSTRACT

Systems and methods for stochastic modeling for drilling forecasts. One embodiment includes determining a plurality of potential well sites and a well attribute, determining available assets for drilling a well, and determining historical wells with a similar attribute. Some embodiments include using a stochastic process to estimate drilling costs and drilling times for drilling the well at each of the plurality of potential well sites, generating a predetermined number of drilling schedules for the plurality of potential well sites, and predicting a cost and time estimate for drilling of each well at the plurality of potential well sites for each of the predetermined number of drilling schedules. Some embodiments include determining a probability distribution of cost for implementing a subset of the predetermined number of drilling schedules for the predetermined time period and providing the probability distribution of cost for output prior to a start of the predetermined time period.

### TECHNICAL FIELD

Embodiments provided herein generally relate to stochastic modeling for drilling forecasts and, more specifically, to stochastic model potential wells and develop a plan for projecting costs of the potential wells.

### BACKGROUND

In the oil and gas industry, dozens, hundreds, or thousands of new wells may be drilled in a given year. As will be understood, this amounts to a significant investment in both time and money for any particular company. Specifically, each well may have several factors that affect the time for drilling and thus the cost engaged for drilling. Additionally, the company may only have a limited number of rigs for drilling wells. Each of the rigs may be compatible for drilling only a certain type of well and thus, some rigs may not be suitable for drilling other types of wells. As an example, a land-based rig may not be compatible for drilling an off-shore well. Thus, when attempting to account for the scheduling of the rigs and the cost of drilling a well, these factors must be taken into consideration.

Thus, a need exists in the industry for systems and methods for stochastic modeling for drilling forecasts.

### SUMMARY

Systems and methods for stochastic modeling for drilling forecasts. One embodiment includes determining a plurality of potential well sites and a well attribute, determining available assets for drilling a well, and determining historical wells with a similar attribute. Some embodiments include using a stochastic process to estimate drilling costs and drilling times for drilling the well at each of the plurality of potential well sites, generating a predetermined number of drilling schedules for the plurality of potential well sites, and predicting a cost and time estimate for drilling of each well at the plurality of potential well sites for each of the predetermined number of drilling schedules. Some embodiments include determining a probability distribution of cost for implementing a subset of the predetermined number of drilling schedules for the predetermined time period and providing the probability distribution of cost for output prior to a start of the predetermined time period.

In another embodiment, a system includes a drilling rig for drilling a hydrocarbon well at a well site, a drilling rig monitoring system coupled to the drilling rig for detecting at least one attribute of the well site, and rig-up implementation hardware for implementing a desired drilling schedule. Some embodiments include a stochastic modeling computing system that includes a stochastic modeling processor a well site data memory, and a drilling forecast output translation module. The well site data memory may store a drilling forecast software module that, when executed by the processor, causes the system to determine a plurality of potential well sites and a well attribute of the plurality of potential well sites for drilling in a predetermined time period, determine available assets for drilling a well at each of the plurality of potential well sites, where determining the available assets includes determining an asset identifier and an asset type for each of the available assets, and determine a plurality of historical wells with a similar attribute as the well attribute of the plurality of potential well sites. Some embodiments use a stochastic process to estimate a plurality of drilling costs and drilling times for drilling the well at each of the plurality of potential well sites, generate from the plurality of potential well sites, the available assets, and the plurality of historical wells, a predetermined number of drilling schedules for the plurality of potential well sites, and predict a cost and time estimate for drilling of each well at the plurality of potential well sites for each of the predetermined number of drilling schedules. Some embodiments determine from the cost and time estimate, a probability distribution of cost for implementing a subset of the predetermined number of drilling schedules for the predetermined time period, select the desired drilling schedule from the predetermined number of drilling schedules, and commission implementation of the desired drilling schedule, where commissioning implementation of the desired drilling schedule includes utilizing the drilling forecast output translation module to communicate the desired drilling schedule to the rig-up implementation hardware.

In yet another embodiment, a non-transitory computer-readable storage medium includes logic that, when executed by a computing device, causes the computing device to determine a plurality of potential well sites and a well attribute of the plurality of potential well sites for drilling in a predetermined time period, determine by the computing device, available assets for drilling a well at each of the plurality of potential well sites, where determining the available assets includes determining an asset identifier and an asset type for each of the available assets, and determine by the computing device, a plurality of historical wells with a similar attribute as the well attribute of the plurality of potential well sites. Some embodiments are configured to cause the computing device to use a stochastic process to estimate a plurality of drilling costs and drilling times for drilling the well at each of the plurality of potential well sites, generate from the plurality of potential well sites, the available assets, and the plurality of historical wells, a predetermined number of drilling schedules for the plurality of potential well sites, and predict a cost and time estimate for drilling of each well at the plurality of potential well sites for each of the predetermined number of drilling schedules. Similarly, some embodiments cause the computing device to determine from the cost and time estimate, a probability distribution of cost for implementing a subset of the predetermined number of drilling schedules for the predetermined time period, select a desired drilling schedule from the predetermined number of drilling schedules, and commission implementation of the desired drilling schedule.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts a computing environment that provides stochastic modeling for drilling forecasts, according to embodiments provided herein;

FIG. 1B depicts other hardware for a stochastic modeling system that provides input data and implementing results of the stochastic modeling, according to embodiments provided herein;

FIG. 2 depicts a schematic representation of drilling time and drilling cost of a group of wells with similar attributes, according to embodiments provided herein;

FIG. 3 depicts a graphical representation of cost and time estimates for a drilling schedule from a probability density function created from historical records, according to embodiments provided herein;

FIG. 4 depicts drilling schedule generated using the sampled drilling time and drilling cost from which yearly total cost and rig requirements will be determined, according to embodiments provided herein;

FIG. 5 depicts total drilling cost distribution for one of the years generated using a plurality of realizations, according to embodiments provided herein;

FIG. 6 depicts a flowchart for providing stochastic modeling for drilling forecasts, according to embodiments provided herein; and

FIG. 7 depicts a computing device for providing stochastic modeling for drilling forecasts, according to embodiments provided herein.

### DETAILED DESCRIPTION

Embodiments disclosed herein include systems and methods for stochastic modeling for drilling forecasts. Some embodiments are configured to assess a company's hardware assets to determine the various attributes that the company hardware has to perform work. Additionally, an inventory may be taken regarding potential well sites that the company would like to drill within a predetermined time (e.g., within the next year). This potential well site inventory may include determining attributes of the plurality of potential well sites. These embodiments may additionally provide a stochastic analysis that creates a drilling schedule, based on the company hardware and the plurality of potential well sites that can be accomplished within the predetermined time.

In some embodiments, cost and time are determined, which are derived from historical records per well or well category. The projected drilling time and drilling cost estimates for future wells are highly uncertain due to many operational complexities that cannot be fully accounted. Projected drilling time and drilling cost estimates are also parameters that affect the drilling scheduling and the budgeting forecasts. Therefore, quantification of uncertainties due to well cost and drill time is may be useful for risk mitigation and accurate planning.

Some embodiments introduce a stochastic modeling approach in drilling scheduling and budgeting forecast for oil and gas. Some embodiments are configured to quantify uncertainty in development drilling resource planning. The overall plan cost and drilling rig requirements may be dependent on well-by-well cost and drill time, which are uncertain. Therefore, embodiments provided herein quantify these uncertainties. Therefore, the implementation of stochastic modeling in the forecast planning process assessed in quantifying the uncertainties. The systems and methods for systems and methods for stochastic modeling for drilling forecasts incorporating the same will be described in more detail, below.

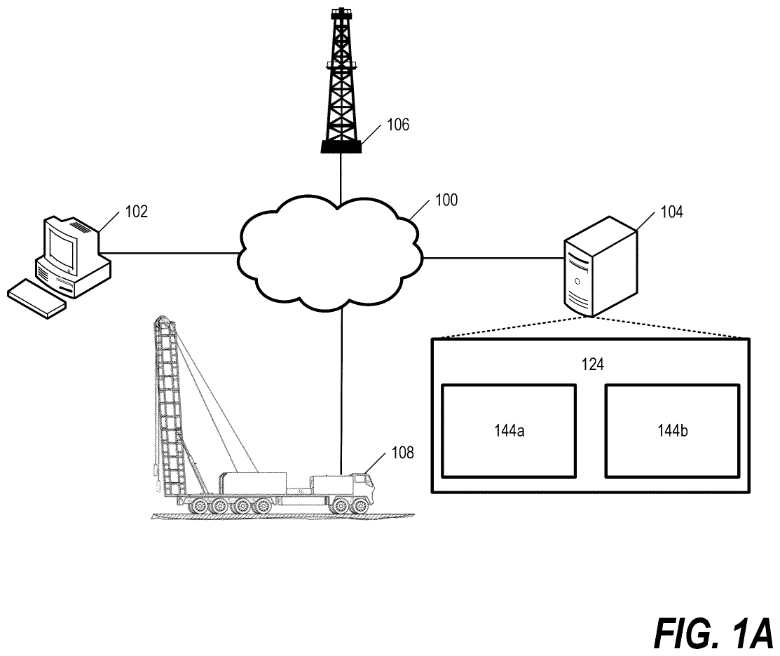

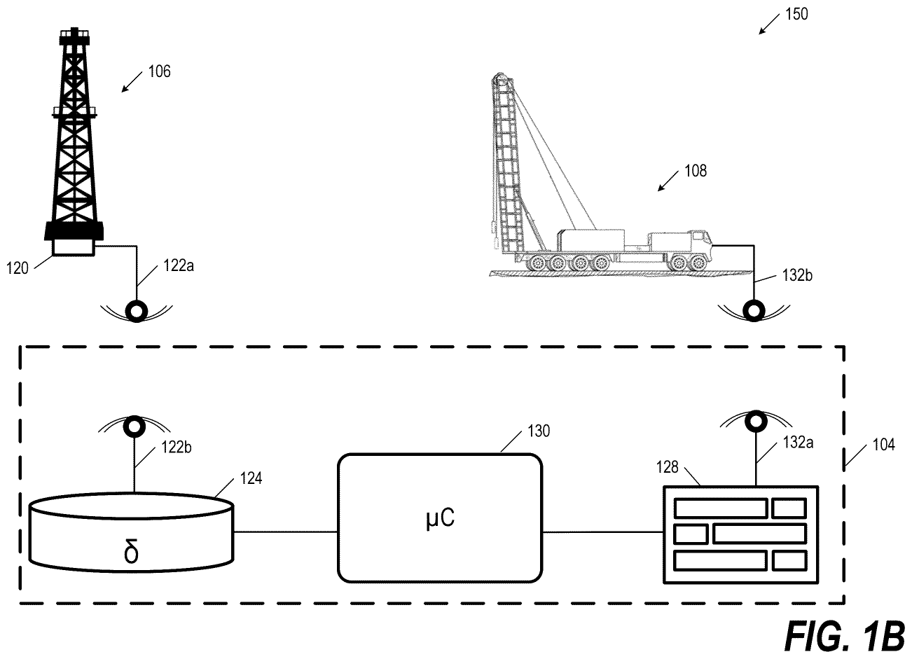

Referring now to the drawings FIG. 1 depicts a computing environment that provides stochastic modeling for drilling forecasts, according to embodiments provided herein. As illustrated, the computing environment may include a network 100 that is coupled to a user computing device 102, a sochastic modeling computing system 104, drilling rig 106, and rig-up implementation hardware 108. The network 100 may be configured as a wide area network (WAN), such as a public switch telephone network, the internet, a cellular network, a WiMax network, and/or the like. The network 100 may include a local network, such as an Ethernet network, a wireless fidelity (Wi-Fi) network, and/or the like. Similarly, the network 100 may be configured as a personal area network and/or peer-to-peer network, such as via Bluetooth, Zigbee, etc.

Coupled to the network 100 is the user computing device 102. The user computing device 102 may be configured as any personal computer, laptop, tablet, mobile device, and/or other computing device that is configured for receiving user input and/or providing user output.

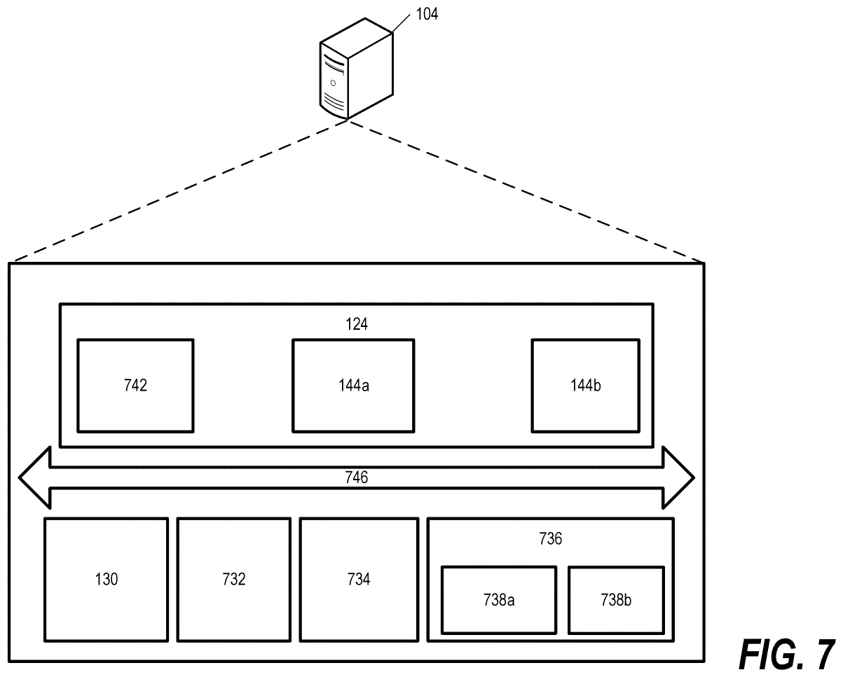

Also coupled to the network 100 is the sochastic modeling computing system 104. The sochastic modeling computing system 104 may similarly be configured as a personal computer, laptop, tablet, mobile device, server and/or other device that may or may not have user interfacing capabilities, but is configured to process historical site data to perform the functionality provided herein. As such, the sochastic modeling computing system 104 may include a well site data memory 124 that stores data collecting logic 144a and modeling logic 144b. As described in more detail below with reference to FIG. 7, the data collecting logic 144a may be configured for collecting historical data associated with costs and time involved with drilling new wells, as well as data associated with current capabilities, such as the drilling rig 106.

Depending on the particular embodiment, this historical data and current capability data may be manually entered by a user (e.g., via the user computing device 102), and/or may be determined by sensor or other electronic mechanism and communicated such as via an internet of things (IoT) or other network registry protocol. Specifically, some embodiments may include one or more sensors on the drilling rig 106 that are configured to detect an attribute of the drilling rig 106 and communicate with the sochastic modeling computing system 104, such that the data collecting logic 144a may collect the desired data. As also described in more detail below, the modeling logic 144b may be configured to cause the sochastic modeling computing system 104 to process the received historical data and current capability data and may create a model that includes a drilling schedule and cost associated with that drilling schedule.

The drilling rig 106 is also coupled to the network 100 and may include any drilling hardware, such as drilling rigs and other hardware for drilling and/or operating a well. Specifically, drilling rig 106 represents hardware that may currently exist (or previously existed) on well sites of previously drilled wells and/or sites where future drilling will occur. While a drilling rig is depicted, this is meant to represent any hardware that performs these functions. As stated above, this drilling rig 106 may additionally include any sensors, transmitters, receivers, predictive simulations, and/or computing infrastructure to collect and/or communicate data associated with drilling or operating an historical well and/or a potential well. For example, and in embodiments, the drilling rig monitoring system may include used or predicted fluid totals, used or predicted additive totals, previous or predicted energy consumption, historical down-time, drilling depth, drilling speed, etc. that may be catalogued by the computing infrastructure of the drilling rig monitoring system during the drilling or operating of the historical well and/or the simulation of the potential well.

Also coupled to the network 100 is the rig-up implementation hardware 108. The rig-up implementation hardware 108 may include transportation hardware (such as trucks), construction hardware, computing infrastructure, and/or any sensors for implementing a drilling schedule, as described herein.

FIG. 1B depicts a stochastic modeling system 150 that provides input data and implements results of stochastic modeling, according to embodiments provided herein. As illustrated, the drilling rig 106 may include drilling rig monitoring system 120 that may detect an attribute about a well site (past and/or potential). In some embodiments, the drilling rig monitoring system 120 may include or be coupled to at least one sensor, as well as a storage device that stores an identifier of the hardware and a type of the hardware. Some embodiments may include a flow meter or other physical sensors for determining volume and/or composition of the reservoir and/or other information for categorizing the well, as described in more detail below. The drilling rig 106 may also include and/or be coupled with a transmitter 122a (which may be configured as a transmitter, receiver and/or a transceiver) for communicating the data from drilling rig monitoring system 120 to the sochastic modeling computing system 104.

It will be understood that on sites that have a plurality of different pieces of hardware, each piece of hardware may be equipped with a radio frequency (RF) tag or other transmitter that may broadcast or otherwise communicate this sensor data to the sochastic modeling computing system 104. In some embodiments, each piece of hardware on a site may be coupled with a computing device that collects and organizes the data before sending to the sochastic modeling computing system 104. It will also be understood that each site may have drilling rig 106 and the associated sensors, communication hardware, and computing infrastructure for communicating with the sochastic modeling computing system 104.

It should also be understood that “sensor data” may include hardware data 738a (FIG. 7), site data 738b (FIG. 7) and/or other data about sites of previously drilled wells, potential wells, or potential well sites. This data may additionally include any financial data associated with the costs of those projects, which may also be classified as site data 738b. Additionally, sensor data may include an identifier of drilling rig 106, a type of site hardware, readings from a sensor, and/or other data related to a well site.

The sochastic modeling computing system 104 may also include or be coupled with a receiver 122b (which may be configured as a transmitter, receiver and/or a transceiver) for receiving the sensor data from the drilling rig 106 associated with a plurality of different sites. Depending on the embodiment, the sochastic modeling computing system 104 may receive sensor data from dozens, hundreds, or even thousands of different pieces of hardware at different past, present, or future well sites or other locations across the globe. The sochastic modeling computing system 104 may include well site data memory 124 (denoted in FIG. 1B as δ) for storing the received sensor data. Depending on the particular embodiment, the well site data memory 124 may be configured as random access memory (RAM), read only memory (ROM), registers, a database, and/or other hardware for storing the sensor data. As such, the well site data memory 124 may include or be part the data storage component 736 (FIG. 7), and/or part of other data storage infrastructure.

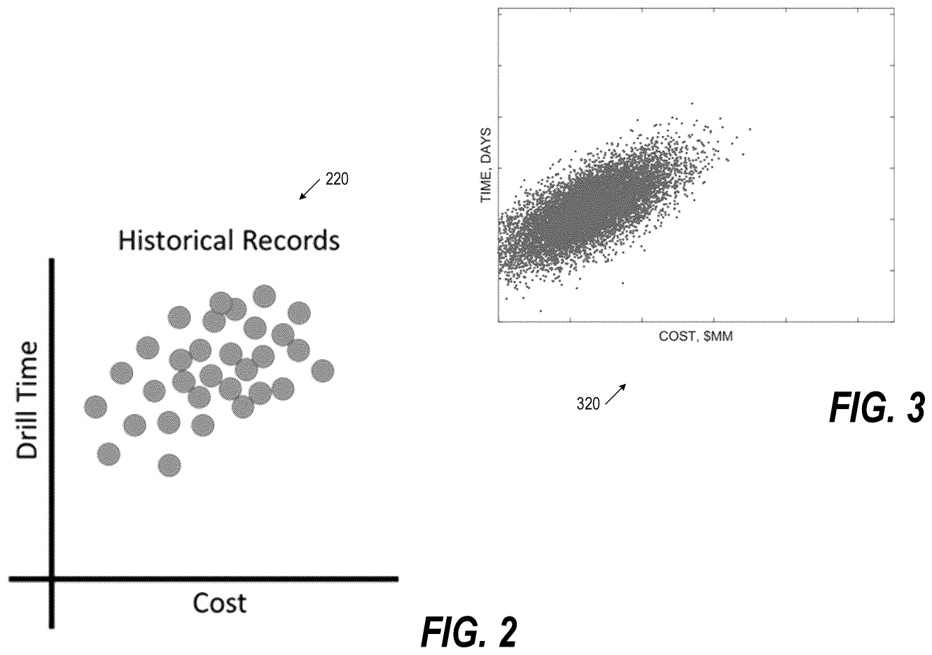

A drilling forecast software module 130 (denoted in FIG. 1B as μC), represents software operations that are performed on the sensor data obtained from the technical operations. The drilling forecast software module 130 may include one or more pieces of software (such as the data collecting logic 144a, the modeling logic 144b, and/or other logical modules) and may be configured for modeling of historical data to predict future drilling schedule and associated cost probability, as described with reference to FIGS. 2-6.

The sochastic modeling computing system 104 may also include a drilling forecast output translation module 128 that is configured to create instructions to implement the results of this analysis. The drilling forecast output translation module 128 may comprise any hardware configured to translate the output of the software module into a form that can be used in the control of technical operations within the system and which, for example, may comprise a hardware driver or controller, a control data transmitter, a document printer, a data display, or any other hardware that generates an operations output that can be used in the system to alter, enhance, or otherwise control technical operations or create a technical effect within the system. The output translation module 128 may be configured as part of the drilling forecast software module 130 and/or may be configured as a separate piece of hardware and/or software. These instructions may be communicated via a transmitter 132a, (which may or may not be the same hardware as receiver 122b) to the rig-up implementation hardware 108. As described above, the rig-up implementation hardware 108 may include hardware for mobilizing the site hardware, and/or computing infrastructure for providing personnel with instructions to implement the drilling schedule. The rig-up implementation hardware 108 may include or be coupled with a receiver 132b for receiving the instructions and implementing the drilling schedule. Implementing the drilling schedule may include securing new well sites, sending drilling rig 106 to the new well sites, instructing personnel to work on the new well sites, and/or performing other tasks for implementing the drilling schedule.

FIG. 2 depicts a schematic representation 220 of drilling time and drilling cost of a group of wells with similar attributes as possible well sites, according to embodiments provided herein. Specifically, a drilling schedule may be produced; may involve producing a development drilling plan; and may include identifying resources to implement the development drilling plan. Producing the development plan may include determining a number of possible well sites on which to drill a well and attributes of the potential wells (e.g., vertical well, a single lateral well, a multi-lateral well, oil producer, gas producer, water injector, a producer, on shore, off shore, new well, a re-entry well, a workover well, etc.). Identifying the resources includes estimating the capital expenditure to execute the development drilling plan. This estimate may be updated periodically (e.g., daily, weekly, monthly, annually, etc.).

For reliable forecasts and resource allocation, a drilling schedule may be generated. A drilling schedule may contain forecasts of the start of drilling of every projected well, the completion time of drilling, and an identifier and type of the drilling hardware (e.g., drilling rig) that will be used to drill the well, etc. These forecasts may take many factors into consideration, such as the location of the well (e.g., onshore, offshore, location relative to appropriate drilling rig 106), the type of the well (e.g., horizontal, vertical, deviated), the capacity of the well, the topography of the well site, etc. The wells may also be categorized into well categories, based on these factors.

For each well in the drilling schedule, a cloud of possible costs and drill times is created from historical data. The cloud is defined by identifying a group of similar wells from history for each well in the plan. Referring again to FIG. 2, the schematic representation 220 depicts a cloud of variation of cost and drill time of one of a plurality of groups of wells. The cloud is obtained by filtering a listing of wells drilled in the past that have common attributes, which is detailed in U.S. Patent Publication Number 2021/0348509, entitled “Systems and Methods for Estimating Well Parameters and Drilling Wells,” which is hereby incorporated by reference in its entirety.

From the cloud of data shown in FIG. 2, a two-dimensional normal probability distribution may be created based on data for each well or well category. These distributions may be used to sample drilling time and drilling cost for each drilling schedule. Fitted distributions may be created based on the following parameters derived from the data: average cost and drill time, standard deviation, minimum and maximum values, covariance of cost and time, etc.

FIG. 3 depicts a graphical representation 320 of cost and time estimates for a drilling schedule from a probability density function created from historical records, according to embodiments provided herein. Specifically, the probability density function can be utilized to generate cost and time estimates per well, based on a proposed drilling schedule. The graphical representation 320 provides estimates of drilling time and drilling cost generated from the created probability density function.

As an example, 10,000 drilling schedules may be created as described in U.S. Patent Publication Number 2021/0350335 entitled “Systems and Methods for Automatic Generation of Drilling Schedules Using Machine Learning,” which is hereby incorporated by reference in its entirety. One component before a drilling schedule can be developed is to estimate a priori drilling cost and drilling time for each potential well. To estimate drilling cost and drilling time for each well, a stochastic process may be utilized, where fitted distributions are used to draw at random a drilling cost and drilling time values for each of the plurality of potential well sites. Additionally, a sample of drilling time and drilling cost may be drawn from the created probability distribution for a given well. Plotting the cost and drilling time values used in the 10,000 drilling schedules, provides the result from FIG. 3.

An example probability density function calculation, which may be plotted in FIG. 3 may include:

$$f ( c , t ) = \frac{1}{2 π {σ}_{cost} {σ}_{time} \sqrt{1 - {ρ}^{2}}} exp ( \frac{- 1}{2 ( 1 - {ρ}^{2} )} [ {( \frac{c - {μ}_{cost}}{{σ}_{cost}} )}^{2} - 2 ρ ( \frac{c - {μ}_{cost}}{{σ}_{cost}} ) ( \frac{t - {μ}_{time}}{{σ}_{time}} ) + {( \frac{t - {μ}_{time}}{{σ}_{time}} )}^{2} ] )$$

Where f represents the bi-normal probability density function for cost and time, c represents cost, t represents time, μ_{cost} represents the arithmetic average of the cost, μₜᵢₘₑ represents the arithmetic average of the time, σ_{cost} represents the variance of cost, σₜᵢₘₑ represents the variance of time, and ρ represents the correlation coefficient between cost and time. From the probability density function defined above, a sample of any size can be generated (such as sing Inversion method) and plotted as in FIG. 3.

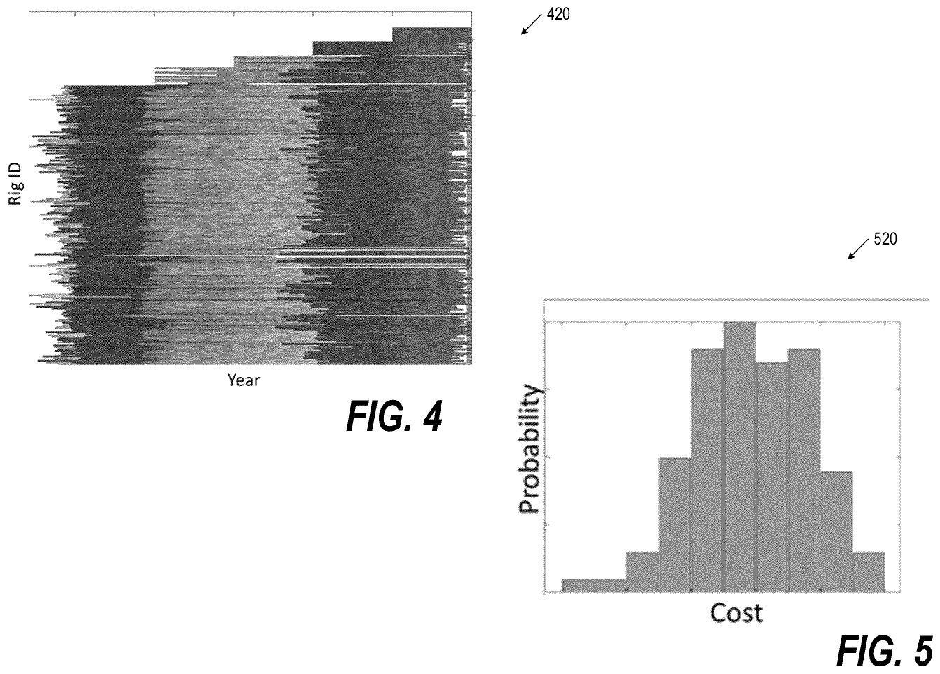

FIG. 4 depicts drilling schedule generated using the sampled drilling time and drilling cost from which yearly total cost and rig requirements may be determined, according to embodiments provided herein. Specifically, embodiments may be configured to predict drilling time and drilling cost for each of the plurality of wells. This prediction is based on running predetermined number of drilling schedules in which the drilling time and drilling cost of each well is drawn from a probability density function created from historical data. As described above, embodiments provided herein utilize a stochastic modeling approach. As an example, one hundred (100) realizations may be performed. In each realization, a detailed drilling schedule may be developed, and an annual cost and rig requirements may be determined. FIG. 4 depicts one of the realizations. As illustrated in FIG. 4, each horizontal line represents one rig being used for a well. The horizontal length of the line represents the time that the rig was used for drilling that particular well. From the 100 realizations, the total cost for one of the years was computed.

FIG. 5 depicts total drilling cost distribution for one of the years generated using a plurality of realizations, according to embodiments provided herein. As illustrated, the depicted histogram may provide a range of uncertainty in the total cost to be anticipated during the planning phase for the drilling schedule of FIG. 4. Once the drilling schedule is determined, a probability cost function may be calculated, which provides the range of cost that the entire drilling schedule may incur. As illustrated, the most likely costs are the median costs, with the lowest probabilities being the highest and lowest costs. This information (populated with actual probabilities and cost figures) may be output to a user.

Specifically, FIG. 5 represents a histogram of cost values calculated from multiple drilling schedules (such as the one shown in FIG. 4) for a given year (e.g., 2024). The table below provides a sample calculation for one of the years. First the equation below may be utilized to calculate a total cost to drill wells in 2024 from a single drilling schedule:

$$Total drilling cost in 2024 = {\sum }_{i = 1}^{n} ( \frac{Partial drill time of well ( i ) in 2024}{Total drill cost of well ( i )} ) * Total drill cost of well ( i )$$

where n is the total number of wells drilled fully or partly in 2024. It will be understood that 2024 may be replaced with any predetermined time period (PTP).

This calculation may be repeated for the generated drilling schedules and available years. The results of total drilling cost may then be organized into buckets that may be used to provide the histogram depiction of FIG. 5.

| Drilling Schedule | | |
|---|---|---|
| ID | Year | Total drilling cost in year 2024 in Billions $ |
| 1 | 2024 | 10.5 |
| 2 | 2024 | 12.1 |
| 3 | 2024 | 11.0 |
| . . . | . . . | . . . |

Some embodiments may be configured with one or more user options for the user to alter the cost and/or probabilities. In such embodiments, the drilling schedule may be adjusted to accommodate the revised cost distribution. Specifically, some embodiments may provide a user option to alter the total probability distribution of cost. In such an embodiment, the user may determine a high, low, median, and/or other feature of the probability distribution of cost in FIG. 5. This alteration may be implemented by the sochastic modeling computing system 104 altering at least one feature of the plurality of drilling schedules, such as number of wells to be drilled, maximum travel distance, number of land-based wells, off-shore wells, etc. Once the alteration to the drilling schedule has been made, the probability distribution of cost may be again determined and a determination may be made regarding whether the drilling schedule, as revised, accommodates the parameters for probability distribution of cost. If so, this may be implemented as described above. If not, the process may provide further constraints on the drilling schedule and the process may be repeated.

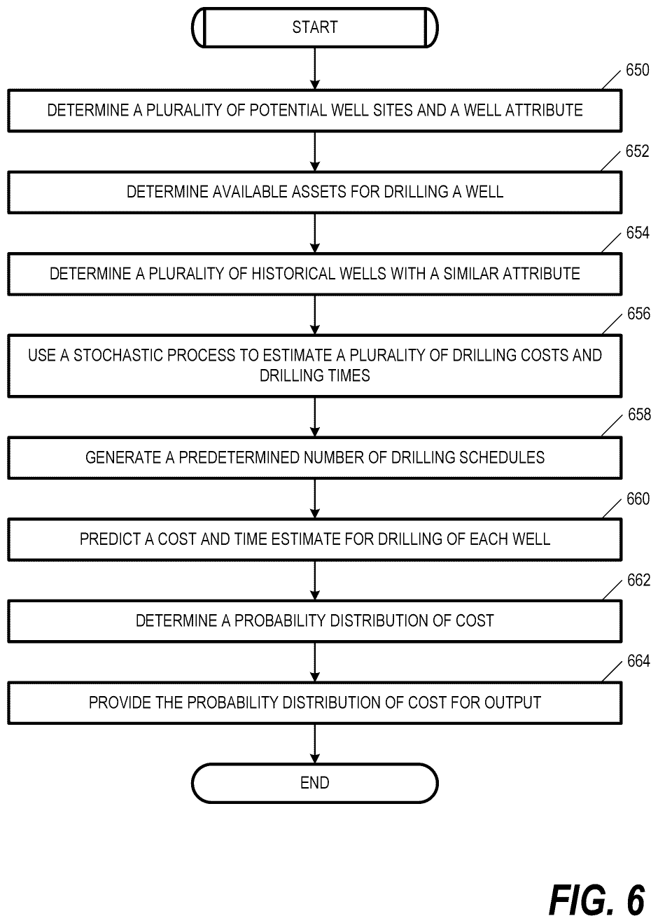

FIG. 6 depicts a flowchart for providing stochastic modeling for drilling forecasts, according to embodiments provided herein. As illustrated in block 650, a plurality of potential well sites and a well attribute of the plurality of potential well sites may be determined for drilling in a predetermined time period. Depending on the embodiment, the predetermined time period may be the next week, month, year, but is often the next billing or accounting cycle. In block 652, available assets (such as drilling hardware) may be determined for drilling a well at each of the plurality of potential well sites. In some embodiments, determining the available assets includes determining an asset identifier and an asset type for each of the available assets.

In block 654, a plurality of historical wells with a similar attribute as the attribute of the plurality of potential well sites may be determined. In block 656, a stochastic process may be utilized to estimate a plurality of drilling costs and drilling times for drilling a well at each of the plurality of potential well sites. In block 658, a predetermined number of drilling schedules for the plurality of potential well sites may be generated from the plurality of potential well sites, the available assets, and the plurality of historical wells. In block 660, a cost and time estimate may be predicted for drilling of each well at the plurality of potential well sites for each of the predetermined number of drilling schedules. In block 662 a probability distribution of cost for implementing a subset of the predetermined number of drilling schedules for the predetermined time period may be determined from the cost and time estimate. In block 664, the probability distribution of cost may be provided for output prior to the start of the predetermined time period.

Similarly, some embodiments may be configured for selecting a desired drilling schedule from the predetermined number of drilling schedules to implement. This may include determining a desired drilling schedule based on a predicted cost, predicted time for completion, predicted wear on equipment, and/or based on other reasons. Once the desired drilling schedule is selected embodiments may be configured for commissioning implementation of the desired drilling schedule. Commissioning implementation of the desired drilling schedule, may include electronically reserving the equipment for the desired location, as well as ordering movement of the equipment according to the desired time for start of drilling and the location.

FIG. 7 depicts a computing device for providing stochastic modeling for drilling forecasts, according to embodiments provided herein. As illustrated, the sochastic modeling computing system 104 includes the processor 730, input/output hardware 732, a network interface hardware 734, a data storage component 736 (which stores code and rules data 738a, patient data 738b, and/or other data, as described with reference to FIGS. 3-5), and a well site data memory 124. The well site data memory 124 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the sochastic modeling computing system 104 and/or external to the sochastic modeling computing system 104.

The well site data memory 124 may store operating logic 742, the data collecting logic 144a, and the modeling logic 144b. Each of these logic components may include a plurality of different pieces of logic, each of which may be embodied as a computer program, firmware, and/or hardware, as an example. A local communication interface 746 is also included in FIG. 7 and may be implemented as a bus or other communication interface to facilitate communication among the components of the sochastic modeling computing system 104.

The processor 730 may include any processing component operable to receive and execute instructions (such as from a data storage component 736 and/or the well site data memory 124). As described above, the input/output hardware 732 may include and/or be configured to interface with speakers, microphones, and/or other input/output components.

The network interface hardware 734 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the sochastic modeling computing system 104 and other computing devices.

The operating logic 742 may include an operating system and/or other software for managing components of the sochastic modeling computing system 104. As discussed above, the data collecting logic 144a may reside in the well site data memory component 124 and may be configured to cause the processor 708 to receive data regarding the historical wells, the available drilling hardware, and/or other information and format that data for processing. The modeling logic 144b may be configured for causing a computing device (such as the sochastic modeling computing system 104) to analyze the extracted data to identify possible issues with the patient and determine CDI alerts, as provided herein.

It should be understood that while the components in FIG. 7 are illustrated as residing within the sochastic modeling computing system 104, this is merely an example. In some embodiments, one or more of the components may reside external to the sochastic modeling computing system 104 or within other devices, such as the user computing device 102 depicted in FIG. 1. It should also be understood that, while the sochastic modeling computing system 104 is illustrated as a single device, this is also merely an example. In some embodiments, the data collecting logic 144a and the modeling logic 144b may reside on different computing devices.

As an example, one or more of the functionalities and/or components provided herein may be provided by the sochastic modeling computing system 104 and/or the user computing device 102. Depending on the particular embodiment, any of these devices may have similar components as those depicted in FIG. 7. To this end, any of these devices may include logic for performing the functionality provided herein.

Additionally, while the sochastic modeling computing system 104 is illustrated with the data collecting logic 144a and the modeling logic 144b as separate logical components, this is also an example. In some embodiments, a single piece of logic may provide the described functionality. It should also be understood that while the data collecting logic 144a and the modeling logic 144b are provided herein as the logical components, this is also an example. Other components may also be included, depending on the embodiment.

As illustrated above, various embodiments for stochastic modeling for drilling forecasts are disclosed. These embodiments may be configured to determine drilling schedules, determine cost probabilities, and provide the cost probabilities to a user for more accurately predicting monetary and asset investment in a drilling schedule. Embodiments may perform what a human could not perform, due to the vast amount of data that is calculated.

While particular embodiments and aspects of the present disclosure have been illustrated and provided herein, various other changes and modifications can be made without departing from the spirit and scope of the disclosure. Moreover, although various aspects have been provided herein, such aspects need not be utilized in combination. Accordingly, it is therefore intended that the appended claims cover all such changes and modifications that are within the scope of the embodiments shown and provided herein.

Various aspects for stochastic modeling are disclosed. Specifically, a first aspect includes a system for stochastic modeling for drilling forecasts comprising: a drilling rig for drilling a hydrocarbon well at a well site; a drilling rig monitoring system coupled to the drilling rig for detecting at least one attribute of the well site; rig-up implementation hardware for implementing a desired drilling schedule; and a stochastic modeling computing system that includes a stochastic modeling processor a well site data memory, and a drilling forecast output translation module, the well site data memory storing a drilling forecast software module that, when executed by the processor, causes the system to perform at least the following: determine a plurality of potential well sites and a well attribute of the plurality of potential well sites for drilling in a predetermined time period; determine available assets for drilling a well at each of the plurality of potential well sites, wherein determining the available assets includes determining an asset identifier and an asset type for each of the available assets; determine a plurality of historical wells with a similar attribute as the well attribute of the plurality of potential well sites; use a stochastic process to estimate a plurality of drilling costs and drilling times for drilling the well at each of the plurality of potential well sites; generate from the plurality of potential well sites, the available assets, and the plurality of historical wells, a predetermined number of drilling schedules for the plurality of potential well sites; predict a cost and time estimate for drilling of each well at the plurality of potential well sites for each of the predetermined number of drilling schedules; determine from the cost and time estimate, a probability distribution of cost for implementing a subset of the predetermined number of drilling schedules for the predetermined time period; select the desired drilling schedule from the predetermined number of drilling schedules; and commission implementation of the desired drilling schedule, wherein commissioning implementation of the desired drilling schedule includes utilizing the drilling forecast output translation module to communicate the desired drilling schedule to the rig-up implementation hardware.

A second aspect includes the system of the first aspect, wherein the well attribute includes at least one of the following: vertical well, a single lateral well, a multi-lateral well, oil producer, gas producer, water injector, a producer, on shore, off shore, new well, a re-entry well, or a workover well.

A third aspect includes the first aspect and/or the second aspect, wherein the drilling forecast software module further causes the system to categorize the plurality of potential well sites according to at least one of the following: a location of each of the plurality of potential well sites, a type of the well to be drilled, a capacity of the well, or a topography of each of the plurality of potential well sites.

A fourth aspect includes any of the first aspect through the third aspect, wherein the cost and time estimate is generated utilizing a probability density function can be utilized to generate cost and time estimates per well, based on a proposed drilling schedule.

A fifth aspect includes any of the first aspect through the fourth aspect, wherein predicting a cost and time estimate for each well includes drawing from a probability density function created from data associated with the plurality of historical wells.

A sixth aspect includes any of the first aspect through the fifth aspect, wherein the predetermined number of drilling schedules includes forecasts of a start of drilling of each well, a completion time of drilling each well, the asset identifier, and the asset type that will be used to drill each well.

A seventh aspect includes any of the first aspect through the sixth aspect, wherein the rig-up implementation hardware implements at least a portion of the desired drilling schedule.

An eighth aspect includes method for stochastic modeling for drilling forecasts comprising: determining, by a computing device, a plurality of potential well sites and a well attribute of the plurality of potential well sites for drilling in a predetermined time period; determining, by the computing device, available assets for drilling a well at each of the plurality of potential well sites, wherein determining the available assets includes determining an asset identifier and an asset type for each of the available assets; determining, by the computing device, a plurality of historical wells with a similar attribute as the well attribute of the plurality of potential well sites; using a stochastic process, by the computing device, to estimate a plurality of drilling costs and drilling times for drilling the well at each of the plurality of potential well sites; generating, by the computing device, from the plurality of potential well sites, the available assets, and the plurality of historical wells, a predetermined number of drilling schedules for the plurality of potential well sites; predicting, by the computing device, a cost and time estimate for drilling of each well at the plurality of potential well sites for each of the predetermined number of drilling schedules; determining, by the computing device, from the cost and time estimate, a probability distribution of cost for implementing a subset of the predetermined number of drilling schedules for the predetermined time period; and providing, by the computing device, the probability distribution of cost for output prior to a start of the predetermined time period.

A ninth aspect includes the eighth aspect, wherein the well attribute includes at least one of the following: vertical well, a single lateral well, a multi-lateral well, oil producer, gas producer, water injector, a producer, on shore, off shore, new well, a re-entry well, or a workover well.

A tenth aspect includes the eighth and/or the ninth aspect, further comprising categorizing the plurality of potential well sites according to at least one of the following: a location of each of the plurality of potential well sites, a type of the well to be drilled, a capacity of the well, or a topography of each of the plurality of potential well sites.

An eleventh aspect includes any of the eighth aspect through the tenth aspect, wherein the cost and time estimate is generated utilizing a probability density function can be utilized to generate cost and time estimates per well, based on a proposed drilling schedule.

A twelfth aspect includes any of the eighth aspect through the eleventh aspect, wherein the probability density function is represented by calculating:

$$f ( c , t ) = \frac{1}{2 π {σ}_{cost} {σ}_{time} \sqrt{1 - {ρ}^{2}}} exp ( \frac{- 1}{2 ( 1 - {ρ}^{2} )} [ {( \frac{c - {μ}_{cost}}{{σ}_{cost}} )}^{2} - 2 ρ ( \frac{c - {μ}_{cost}}{{σ}_{cost}} ) ( \frac{t - {μ}_{time}}{{σ}_{time}} ) + {( \frac{t - {μ}_{time}}{{σ}_{time}} )}^{2} ] )$$

where f represents the probability density function for cost and time, c represents cost, t represents time, μ_{cost} represents arithmetic average of the cost, μₜᵢₘₑ represents arithmetic average of time, σ_{cost} represents variance of cost, σₜᵢₘₑ represents variance of time, and ρ represents a correlation coefficient between cost and time.

A thirteenth aspect includes any of the eighth aspect through the twelfth aspect, wherein predicting a cost and time estimate for each well includes drawing from a probability density function created from data associated with the plurality of historical wells.

A fourteenth aspect includes any of the eighth aspect through the thirteenth aspect, wherein the predetermined number of drilling schedules includes forecasts of a start of drilling of each well, a completion time of drilling each well, the asset identifier and the asset type that will be used to drill each well.

A fifteenth aspect includes any of the eighth aspect through the fourteenth aspect, wherein the cost and time estimate is calculated using

$${\sum }_{i = 1}^{n} ( \frac{Partial drill time of well ( i ) in PTP}{Total drill cost of well ( i )} ) * Total drill cost of well ( i )$$

where n is a total number of wells drilled fully or partly in the predetermined time period (PTP).

A sixteenth aspect includes any of the eighth aspect through the fifteenth aspect. further comprising: receiving an indication to alter the probability distribution of cost; determining a number of revised drilling schedules, based on the indication; and providing at least one of the number of revised drilling schedules for output.

A seventeenth aspect includes any of the eighth aspect through the sixteenth aspect, further comprising: selecting a desired drilling schedule from the predetermined number of drilling schedules; and commissioning implementation of the desired drilling schedule.

An eighteenth aspect includes any of the eighth aspect through the seventeenth aspect, wherein using the stochastic process includes utilizing fitted distributions to draw at random a drilling cost and drilling time values for each of the plurality of potential well sites.

A nineteenth aspect includes a non-transitory computer-readable storage medium that that stores logic that, when executed by a computing device, causes the computing device to perform at least the following: determine a plurality of potential well sites and a well attribute of the plurality of potential well sites for drilling in a predetermined time period; determine by the computing device, available assets for drilling a well at each of the plurality of potential well sites, wherein determining the available assets includes determining an asset identifier and an asset type for each of the available assets; determine by the computing device, a plurality of historical wells with a similar attribute as the well attribute of the plurality of potential well sites; use a stochastic process to estimate a plurality of drilling costs and drilling times for drilling the well at each of the plurality of potential well sites; generate from the plurality of potential well sites, the available assets, and the plurality of historical wells, a predetermined number of drilling schedules for the plurality of potential well sites; predict a cost and time estimate for drilling of each well at the plurality of potential well sites for each of the predetermined number of drilling schedules; determine from the cost and time estimate, a probability distribution of cost for implementing a subset of the predetermined number of drilling schedules for the predetermined time period; select a desired drilling schedule from the predetermined number of drilling schedules; and commission implementation of the desired drilling schedule.

A twentieth aspect includes the nineteenth aspect, further comprising: categorizing the plurality of potential well sites according to at least one of the following: a location of each of the plurality of potential well sites, a type of the well to be drilled, a capacity of the well, or a topography of each of the plurality of potential well sites, wherein the well attribute includes at least one of the following: vertical well, a single lateral well, a multi-lateral well, oil producer, gas producer, water injector, a producer, on shore, off shore, new well, a re-entry well, or a workover well, wherein the cost and time estimate is generated utilizing a probability density function can be utilized to generate cost and time estimates per well, based on a proposed drilling schedule, and wherein the probability density function is represented by calculating:

$$f ( c , t ) = \frac{1}{2 π {σ}_{cost} {σ}_{time} \sqrt{1 - {ρ}^{2}}} exp ( \frac{- 1}{2 ( 1 - {ρ}^{2} )} [ {( \frac{c - {μ}_{cost}}{{σ}_{cost}} )}^{2} - 2 ρ ( \frac{c - {μ}_{cost}}{{σ}_{cost}} ) ( \frac{t - {μ}_{time}}{{σ}_{time}} ) + {( \frac{t - {μ}_{time}}{{σ}_{time}} )}^{2} ] )$$

where f represents the probability density function for cost and time, c represents cost, t represents time, μ_{cost} represents arithmetic average of the cost, μₜᵢₘₑ represents arithmetic average of time, σ_{cost} represents variance of cost, σₜᵢₘₑ represents variance of time, and ρ represents a correlation coefficient between cost and time.

It should now be understood that embodiments disclosed herein include systems, methods, and non-transitory computer-readable mediums for stochastic modeling for drilling forecasts. It should also be understood that these embodiments are merely exemplary and are not intended to limit the scope of this disclosure.

What is claimed is:

1. A system for stochastic modeling for drilling forecasts comprising:
a drilling rig for drilling a hydrocarbon well at a well site;
a drilling rig monitoring system coupled to the drilling rig for detecting at least one attribute of the well site;
rig-up implementation hardware for implementing a desired drilling schedule; and
a stochastic modeling computing system that includes a stochastic modeling processor a well site data memory, and a drilling forecast output translation module, the well site data memory storing a drilling forecast software module that, when executed by the stochastic modeling processor, causes the system to perform at least the following:
determine a plurality of potential well sites and a well attribute of the plurality of potential well sites for drilling in a predetermined time period;
determine available assets for drilling a well at each of the plurality of potential well sites, wherein determining the available assets includes determining an asset identifier and an asset type for each of the available assets;
determine a plurality of historical wells with a similar attribute as the well attribute of the plurality of potential well sites;
use a stochastic process to estimate a plurality of drilling costs and drilling times for drilling the well at each of the plurality of potential well sites;
generate from the plurality of potential well sites, the available assets, and the plurality of historical wells, a predetermined number of drilling schedules for the plurality of potential well sites;
predict a cost and time estimate for drilling of each well at the plurality of potential well sites for each of the predetermined number of drilling schedules;
determine from the cost and time estimate, a probability distribution of cost for implementing a subset of the predetermined number of drilling schedules for the predetermined time period;
select the desired drilling schedule from the predetermined number of drilling schedules; and
commission implementation of the desired drilling schedule, wherein commissioning implementation of the desired drilling schedule includes utilizing the drilling forecast output translation module to communicate the desired drilling schedule to the rig-up implementation hardware.

2. The system of claim 1, wherein the well attribute includes at least one of the following: vertical well, a single lateral well, a multi-lateral well, oil producer, gas producer, water injector, a producer, on shore, off shore, new well, a re-entry well, or a workover well.

3. The system of claim 1, wherein the drilling forecast software module further causes the system to categorize the plurality of potential well sites according to at least one of the following: a location of each of the plurality of potential well sites, a type of the well to be drilled, a capacity of the well, or a topography of each of the plurality of potential well sites.

4. The system of claim 1, wherein the cost and time estimate is generated utilizing a probability density function can be utilized to generate cost and time estimates per well, based on a proposed drilling schedule.

5. The system of claim 1, wherein predicting a cost and time estimate for each well includes drawing from a probability density function created from data associated with the plurality of historical wells.

6. The system of claim 1, wherein the predetermined number of drilling schedules includes forecasts of a start of drilling of each well, a completion time of drilling each well, the asset identifier, and the asset type that will be used to drill each well.

7. The system of claim 1, wherein the rig-up implementation hardware implements at least a portion of the desired drilling schedule.

8. A method for stochastic modeling for drilling forecasts comprising:
determining, by a computing device, a plurality of potential well sites and a well attribute of the plurality of potential well sites for drilling in a predetermined time period;
determining, by the computing device, available assets for drilling a well at each of the plurality of potential well sites, wherein determining the available assets includes determining an asset identifier and an asset type for each of the available assets;
determining, by the computing device, a plurality of historical wells with a similar attribute as the well attribute of the plurality of potential well sites;
using a stochastic process, by the computing device, to estimate a plurality of drilling costs and drilling times for drilling the well at each of the plurality of potential well sites;
generating, by the computing device, from the plurality of potential well sites, the available assets, and the plurality of historical wells, a predetermined number of drilling schedules for the plurality of potential well sites;
predicting, by the computing device, a cost and time estimate for drilling of each well at the plurality of potential well sites for each of the predetermined number of drilling schedules;
determining, by the computing device, from the cost and time estimate, a probability distribution of cost for implementing a subset of the predetermined number of drilling schedules for the predetermined time period; and
providing, by the computing device, the probability distribution of cost for output prior to a start of the predetermined time period.

9. The method of claim 8, wherein the well attribute includes at least one of the following: vertical well, a single lateral well, a multi-lateral well, oil producer, gas producer, water injector, a producer, on shore, off shore, new well, a re-entry well, or a workover well.

10. The method of claim 8, further comprising categorizing the plurality of potential well sites according to at least one of the following: a location of each of the plurality of potential well sites, a type of the well to be drilled, a capacity of the well, or a topography of each of the plurality of potential well sites.

11. The method of claim 8, wherein the cost and time estimate is generated utilizing a probability density function can be utilized to generate cost and time estimates per well, based on a proposed drilling schedule.

12. The method of claim 11, wherein the probability density function is represented by calculating:
$$f ( c , t ) = \frac{1}{2 π {σ}_{cost} {σ}_{time} \sqrt{1 - {ρ}^{2}}} exp ( \frac{- 1}{2 ( 1 - {ρ}^{2} )} [ {( \frac{c - {μ}_{cost}}{{σ}_{cost}} )}^{2} - 2 ρ ( \frac{c - {μ}_{cost}}{{σ}_{cost}} ) ( \frac{t - {μ}_{time}}{{σ}_{time}} ) + {( \frac{t - {μ}_{time}}{{σ}_{time}} )}^{2} ] )$$
where f represents the probability density function for cost and time, c represents cost, t represents time, μ_{cost} represents arithmetic average of the cost, μₜᵢₘₑ represents arithmetic average of time, σ_{cost} represents variance of cost, σₜᵢₘₑ represents variance of time, and ρ represents a correlation coefficient between cost and time.

13. The method of claim 8, wherein predicting a cost and time estimate for each well includes drawing from a probability density function created from data associated with the plurality of historical wells.

14. The method of claim 8, wherein the predetermined number of drilling schedules includes forecasts of a start of drilling of each well, a completion time of drilling each well, the asset identifier and the asset type that will be used to drill each well.

15. The method of claim 8, wherein the cost and time estimate is calculated using
$${\sum }_{i = 1}^{n} ( \frac{Partial drill time of well ( i ) in PTP}{Total drill cost of well ( i )} ) * Total drill cost of well ( i )$$
where n is a total number of wells drilled fully or partly in the predetermined time period (PTP).

16. The method of claim 8, further comprising:
receiving an indication to alter the probability distribution of cost;
determining a number of revised drilling schedules, based on the indication; and
providing at least one of the number of revised drilling schedules for output.

17. The method of claim 8, further comprising:
selecting a desired drilling schedule from the predetermined number of drilling schedules; and
commissioning implementation of the desired drilling schedule.

18. The method of claim 8, wherein using the stochastic process includes utilizing fitted distributions to draw at random a drilling cost and drilling time values for each of the plurality of potential well sites.

19. A non-transitory computer-readable storage medium that that stores logic that, when executed by a computing device, causes the computing device to perform at least the following:
determine a plurality of potential well sites and a well attribute of the plurality of potential well sites for drilling in a predetermined time period;
determine by the computing device, available assets for drilling a well at each of the plurality of potential well sites, wherein determining the available assets includes determining an asset identifier and an asset type for each of the available assets;
determine by the computing device, a plurality of historical wells with a similar attribute as the well attribute of the plurality of potential well sites;
use a stochastic process to estimate a plurality of drilling costs and drilling times for drilling the well at each of the plurality of potential well sites;
generate from the plurality of potential well sites, the available assets, and the plurality of historical wells, a predetermined number of drilling schedules for the plurality of potential well sites;
predict a cost and time estimate for drilling of each well at the plurality of potential well sites for each of the predetermined number of drilling schedules;
determine from the cost and time estimate, a probability distribution of cost for implementing a subset of the predetermined number of drilling schedules for the predetermined time period;
select a desired drilling schedule from the predetermined number of drilling schedules; and
commission implementation of the desired drilling schedule.

20. The non-transitory computer-readable storage medium of claim 19, further comprising:
categorizing the plurality of potential well sites according to at least one of the following: a location of each of the plurality of potential well sites, a type of the well to be drilled, a capacity of the well, or a topography of each of the plurality of potential well sites,
wherein the well attribute includes at least one of the following: vertical well, a single lateral well, a multi-lateral well, oil producer, gas producer, water injector, a producer, on shore, off shore, new well, a re-entry well, or a workover well,
wherein the cost and time estimate is generated utilizing a probability density function can be utilized to generate cost and time estimates per well, based on a proposed drilling schedule, and
wherein the probability density function is represented by calculating:
$$f ( c , t ) = \frac{1}{2 π {σ}_{cost} {σ}_{time} \sqrt{1 - {ρ}^{2}}} exp ( \frac{- 1}{2 ( 1 - {ρ}^{2} )} [ {( \frac{c - {μ}_{cost}}{{σ}_{cost}} )}^{2} - 2 ρ ( \frac{c - {μ}_{cost}}{{σ}_{cost}} ) ( \frac{t - {μ}_{time}}{{σ}_{time}} ) + {( \frac{t - {μ}_{time}}{{σ}_{time}} )}^{2} ] )$$
where f represents the probability density function for cost and time, c represents cost, t represents time, μ_{cost} represents arithmetic average of the cost, μₜᵢₘₑ represents arithmetic average of time, σ_{cost} represents variance of cost, σₜᵢₘₑ represents variance of time, and ρ represents a correlation coefficient between cost and time.
